(19) United States
(12) Patent Application Publication
(10) Pub. No.: US 2007/0250442 A1
(43) Pub. Date: Oct. 25, 2007

(54) Financial Transaction Card With Installment Loan Feature

(76) Inventors: Edward J. Hogan, East Quoge, NY (US); Mary Jo Winterer, Norwalk, CT (US); James B. O'Connell, White Plains, NY (US); John Burkley, Briarcliff, NY (US)

Correspondence Address: BAKER BOTTS L.L.P., 30 ROCKEFELLER PLAZA, 44TH FLOOR, NEW YORK, NY, 10112-4498, US

(21) Appl. No.: 11/560,212

(22) Filed: Nov. 15, 2006

Related U.S. Application Data
(63) Continuation-in-part of application No. 10/914,766, filed on Aug. 9, 2004.
Application No. 10/914,766 is a continuation of application No. 09/842,522, filed on Apr. 25, 2001, now Pat. No. 6,793,131.
Application No. 09/842,522 is a continuation of application No. 09/144,287, filed on Aug. 31, 1998, now Pat. No. 6,315,193.

(51) Int. Cl. G06Q 40/00

(52) U.S. Cl. 705/41; 705/39

(57) ABSTRACT

There is provided a financial transaction payment method and system for processing a transaction conducted using a financial transaction card. The financial transaction card has associated therewith a financial account in a financial institution and one or more transaction criteria. The financial transaction payment system includes a processing unit and an application program for execution on the processing unit. The method includes the step of determining by the application program whether a transaction accesses an installment loan on the financial account based on the one or more transaction criteria.

### CROSS-REFERENCE TO RELATED APPLICATIONS

This application is a continuation-in-part of, and claims priority to, application Ser. No. 10/914,766, filed on Aug. 9, 2004, which is a continuation of, and claims priority to, application Ser. No. 09/842,522, filed on Apr. 25, 2001, which is a continuation of, and claims priority to, application Ser. No. 09/144,287, filed on Aug. 31, 1998.

### BACKGROUND OF INVENTION

The present invention relates to a financial transaction payment method and system utilizing financial transaction cards, such as credit cards and debit cards, and to a financial transaction payment method and system involving installment loans, which are loans in which the loan amount and loan interest are repaid in a predetermined number of periodic payments, usually monthly.

Financial transaction cards have made great gains in the United States as a means to attract financial accounts to financial institutions and, in the case of credit cards, as a medium to create small loans and generate interest income for financial institutions. Nonetheless, the financial transaction card industry is subject to certain well-known problems.

Taking the credit card industry, for example, it is well known that the financial institutions issuing credit cards must constantly renew their card account base each year. Typically, in fact, a financial institution must increase its credit card account base by 10% to 12% each year to offset voluntary and involuntary card account transfers and closures. To realize these needed gains, financial institutions are constantly mailing credit card offers to consumers. Such offers usually contain incentives such as no annual fees, delayed payments, and favorable annual percentage rates (APR) to attract new cardholders.

Another problem in the credit card industry is related to the unprofitability of carrying certain types of cardholders. The credit card account base of a financial institution is typically characterized as having two types of cardholders: pay-in-full cardholders (those cardholders that pay their statements in full in each billing cycle) and roll-over cardholders (those cardholders that do not pay their statements in full in each billing cycle, but roll over some of their payments to subsequent billing cycles). On average, the typical account base of a financial institution consists of 25% of pay-in-full cardholders and 75% of roll-over cardholders. Currently, the profitability of the account base of a financial institution is almost entirely attributable to the revenue generated from the interest income from the roll-over cardholders. Nonetheless, the pay-in-full cardholders generate about 50% of the sales activity of the account base. Because of the cost of funds and the lack of receipt of annual fees, the pay-in-full cardholders are a great expense for financial institutions.

Accordingly, it would be desirable to have a financial transaction card method and system that contains a financial feature that is able to attract new cardholders and that can generate added revenue for financial institutions, both from roll-over cardholders and pay-in-full cardholders.

### SUMMARY OF THE INVENTION

The present invention solves the aforementioned problems by providing a system and method for accessing automatically an installment loan based on certain transaction criteria associated with transactions involving a financial transaction card.

Currently, the installment lending market is many times larger than that of the financial transaction card market. Consumers typically use installment loans for paying for such items as travel and large home appliances. Advantageously, by providing a account holder with the ability to obtain an installment loan using a financial transaction card, a financial institution is able to leverage an existing financial account (the financial transaction card account) to provide another service to the account holder. In other words, by providing the convenience of obtaining an installment loan through a financial transaction card account, a account holder is less likely to obtain such a loan from another financial institution.

Because of the size of the installment lending market, it is expected that significant revenue will be generated for a financial institution providing installment loans through financial transaction cards. Moreover, the convenience of obtaining an installment loan through a financial transaction card may also be used as a strong incentive to lure new account holders to a financial institution and, thus, increase the financial institution's financial transaction card account base.

In accordance with a preferred embodiment of the present invention, there is provided a method of conducting a transaction using a financial transaction card in a financial transaction payment system. The financial transaction payment system includes a processing unit and an application program executing on the processing unit. The financial transaction card has associated therewith a financial account in a financial institution and one or more transaction criteria. The method includes the step of determining by the application program whether the transaction accesses an installment loan on the financial account based on the one or more transaction criteria.

Preferably, the financial account has an associated available installment loan credit amount. The method of the present invention then further includes the step of determining by the application program whether the amount of the transaction is greater than the available installment loan credit amount. In addition, the method may also include the step of decreasing by the application program the available installment loan credit amount by the amount of the transaction if the amount of the transaction is less than or equal to the available installment loan credit amount.

It is also preferred that the financial transaction card has associated therewith a primary financial payment function other than accessing an installment loan. For example, the primary financial payment function may be a credit payment function or a debit payment function. In such a case, the method of the present invention also includes the step of processing the transaction by the application program in accordance with the primary financial payment function if the transaction does not access an installment loan on the financial account.

In accordance with another preferred embodiment of the present invention, a method of authorizing a transaction between a consumer and a merchant is also provided. The consumer has a financial transaction card issued by an issuing financial institution, the financial transaction card having associated therewith a financial account with the financial institution, one or more transaction criteria, a primary financial payment processing procedure, and an installment loan processing procedure. The method includes the step of processing an authorization request by the application program using the primary financial payment processing procedure or the installment loan processing procedure depending on whether or not the transaction criteria are met.

Preferably, the method further includes the step of requesting authorization by the merchant from a financial transaction card processing entity that is in electronic communication with the issuing financial institution before the processing step. In addition, the method preferably further includes the steps of capturing by the merchant the transaction if an authorization is received in response to the authorization request, and transmitting by the merchant the captured transaction to the financial transaction card processing entity. In addition, the method may also include the step of settling the transaction by the financial transaction card processing entity with the merchant and the financial institution.

In accordance with yet another preferred embodiment of the present invention, there is also provided a method of setting up an account associated with a financial transaction card of a consumer, which may be used to access one or more installment loans for the payment of one or more transactions. The method is used in connection with a financial transaction payment system that includes a processing unit, an application program for execution on the processing unit, and a memory unit coupled to the processing unit. The method includes the steps of storing by the application program in the memory unit a credit limit for the one or more installment loans that may be accessed with the financial transaction card, and storing by the application program in the memory unit one or more criteria for accessing the one or more installment loans with the financial transaction card. The criteria may include the type of a transaction, the amount of a transaction, and the merchant classification code associated with a merchant involved in a transaction.

Preferably the method further includes the step of storing by the application program in the memory unit payment terms for the one or more installment loans that may be accessed with the financial transaction card. The method may further include the step of storing by the application program in the memory unit an available credit amount for the one or more installment loans that may be accessed with the financial transaction card.

In accordance with yet another preferred embodiment of the present invention, there is provided a method of preparing a statement for transactions conducted using a financial transaction card and stored in the memory unit of a financial transaction processing system, as described above. Each transaction is associated with either a primary financial payment procedure or an installment loan payment procedure. The method includes the steps of: (a) determining by the application program the totals of the transactions associated with the primary financial payment procedure; (b) determining by the application program the totals of the transactions associated with the installment loan payment procedure; and (c) printing by the application program the totals of the transactions associated with the primary financial payment procedure and the totals of the transactions associated with the installment loan payment procedure on the statement.

In accordance with yet another preferred embodiment of the present invention, there is provided a method of processing a payment for a financial transaction card account, the financial transaction card account having an associated installment loan balance and an associated credit balance. The method includes the steps of determining by the application program whether the payment is less than the installment loan balance, and processing by the application program a cash advance against the credit balance equal to the difference between the payment and the installment loan balance, if the payment is less than the installment loan balance.

In accordance with yet another preferred embodiment of the present invention, there is provided a financial transaction payment system for processing a transaction conducted using a financial transaction card. The financial transaction card has associated therewith a financial account with a financial institution and one or more transaction criteria. The financial transaction payment system includes a processing unit; an application program for execution on the processing unit; and means for determining by the application program whether the transaction accesses an installment loan on the financial account based on the one or more transaction criteria.

### BRIEF DESCRIPTION OF THE DRAWINGS

FIGS. 1A and 1B are flowcharts illustrating the steps for setting up a financial transaction card account with an installment loan feature according to a preferred embodiment of the present invention;

FIG. 2 is a flowchart illustrating the steps for processing a transaction in a financial transaction card system with an installment loan feature according to a preferred embodiment of the present invention;

FIGS. 3A and 3B are flowcharts illustrating the steps for processing a statement in a financial transaction card system with an installment loan feature according to a preferred embodiment of the present invention; and

FIGS. 4A and 4B illustrate a statement produced by a financial transaction card system with an installment loan feature in accordance with a preferred embodiment of the present invention.

### DETAILED DESCRIPTION OF THE INVENTION

The present invention is related to a financial transaction card payment system, such as a credit card payment system using the MasterCard® Interchange. The MasterCard® Interchange is a proprietary communications standard promulgated by MasterCard International Incorporated® for the exchange of financial transaction data between financial institutions that are members of MasterCard International Incorporated®.

In a typical financial payment system, a financial institution called the “issuer” issues a financial transaction card, such as a credit card, to a consumer, who uses the financial transaction card to tender payment for a purchase from a merchant. To accept payment with the financial transaction card, the merchant must normally establish an account with a financial institution that is part of the financial payment system. This financial institution is usually called the “merchant bank” or the “acquiring bank.” When the account holder tenders payment for a purchase with a financial transaction card, the merchant requests authorization from the merchant bank for the amount of the purchase. The request may be performed over the telephone, but is usually performed through the use of a point-of-sale terminal, which reads the account holder's account information from the magnetic stripe on the financial transaction card and communicates electronically with the transaction processing computers of the merchant bank. Alternatively, a merchant bank may authorize a third party to perform transaction processing on its behalf. In this case, the point-of-sale terminal will be configured to communicate with the third party. Such a third party is usually called a “merchant processor” or an “acquiring processor.”

Using the interchange, the computers of the merchant bank or the merchant processor will communicate with the computers of the issuer to determine whether the account holder's account is in good standing and whether the purchase is covered by the account holder's available credit line. Based on these determinations, the request for authorization will be declined or accepted. If the request is accepted, an authorization code is issued to the merchant.

When a request for authorization is accepted, the available credit line of the account holder's account is decreased. Normally, a charge is not posted immediately to an account holder's account because bank card associations, such as MasterCard International Incorporated,® have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which are settled as a group.

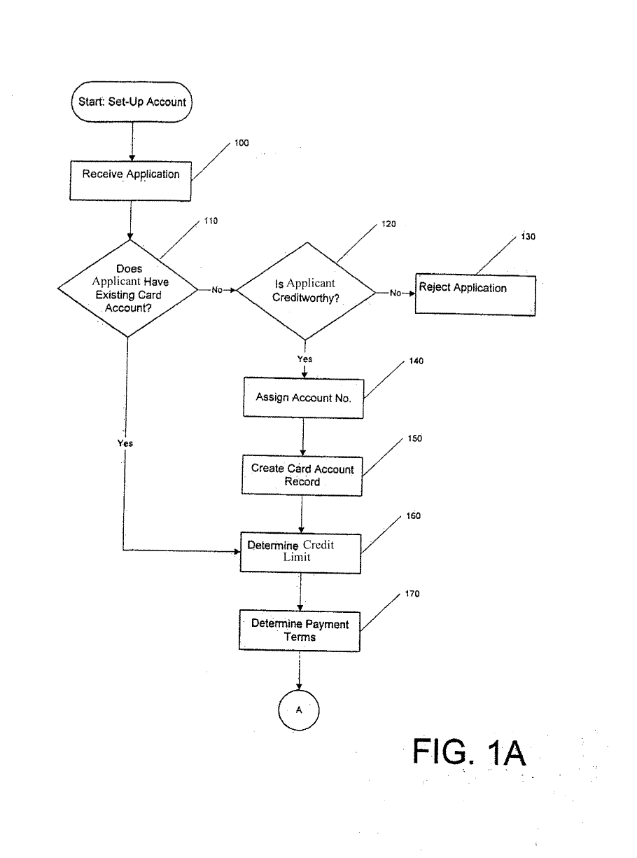

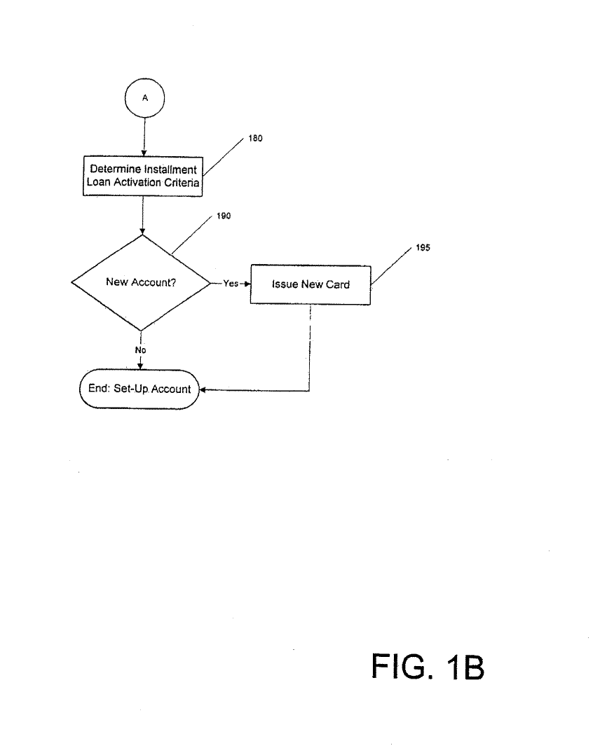

FIGS. 1A and 1B are flowcharts illustrating the steps for setting up a financial transaction card account with an installment loan feature according to a preferred embodiment of the present invention. In step 100, an issuer financial institution receives an application from an entity desiring to obtain a financial transaction card account having an installment loan feature. In one example, there may be three installment card types. One type is the “stand alone” version, in which the account holder acquires a new financial transaction card specifically designed for large purchases to be paid over a fixed period of time. All purchases on this financial transaction card will install. The stand alone version may serve as a companion card to a primary card, which would preferably be a conventional revolving credit card without the installment capability.

A second type may be, for example, a financial transaction card with an “add-on/upgrade” option. In this type of installment card, the account holder may add the installment feature to an existing financial transaction card, expanding the functionality of the existing card to cover both revolving credit and installment (i.e., fixed payment) options. A third type may be, for example, an “all-in-one” option. In this option, an account holder acquires a new financial transaction card that both revolves and has installment options.

The applicant may be an individual consumer, or may be a business, or may also be any other entity or organization. The financial transaction card account having an installment loan feature may be linked to a physical card, such as a conventional credit card, debit card, smart card, etc. Alternatively, the account may not be linked to a physical card at all, but may be linked instead to a non-physical electronic or “virtual” card suitable for use in, for example, electronic commerce transactions.

A virtual financial transaction card account, in accordance with an example of the present invention, is preferably a “card-optional” account. That is to say, a virtual card account need not be issued with a physical card. The virtual financial transaction card account may, for example, be linked to a physical financial transaction card account such that the existence of the virtual financial transaction card is dependent on the existence of the physical financial transaction card account. That is to say, in this exemplary embodiment if the physical card account is cancelled, the virtual card account is also cancelled. Alternatively, the account holder may be have the option of receiving a physical card that is linked to the virtual financial transaction card account. The physical card may, but need not, have the same account number as the virtual financial transaction card account.

In step 110, the financial institution determines, by reviewing the application and its account holder database, whether the account applicant has an existing financial transaction card account. If the applicant does not have an existing financial transaction card account, in step 120, the financial institution determines, by well-established financial industry guidelines, whether the account applicant is creditworthy. If the applicant is not creditworthy, the application is rejected in step 130. If the applicant is determined to be creditworthy, in steps 140 and 150, a financial transaction card account number is assigned to the applicant—now an account holder - and a financial transaction card account record is created in the financial institution's database. The card account record includes such information as the account holder's financial transaction card account number, name, address, and payment balances. The financial transaction card account record may also indicate whether the financial transaction card (whether virtual or physical or both) is linked to, for example, a consumer account or a business account.

In step 160, for both new and existing card accounts, the financial institution determines a credit limit for the account holder. In accordance with an exemplary embodiment of the present invention, the credit limit will preferably apply to the account holder's total combined purchases, regardless of whether those purchases were made using the financial transaction card's (whether physical or virtual) installment loan feature, or using a revolving line of credit. Alternatively, separate credit limits may be determined for the account holder's installment credit purchases, and conventional revolving credit purchases. In either case, the credit limit is preferably determined by well-established industry guidelines based on the account holder's credit history.

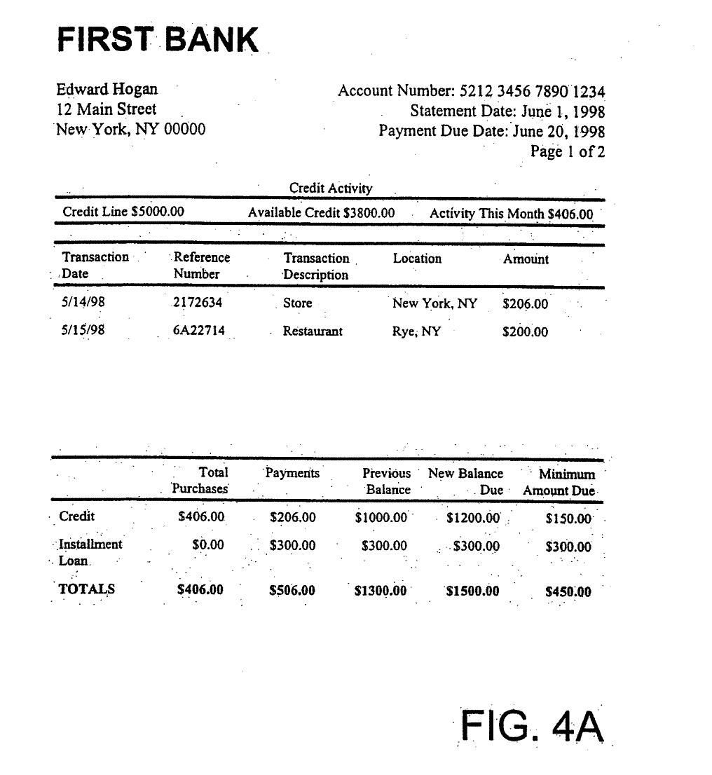

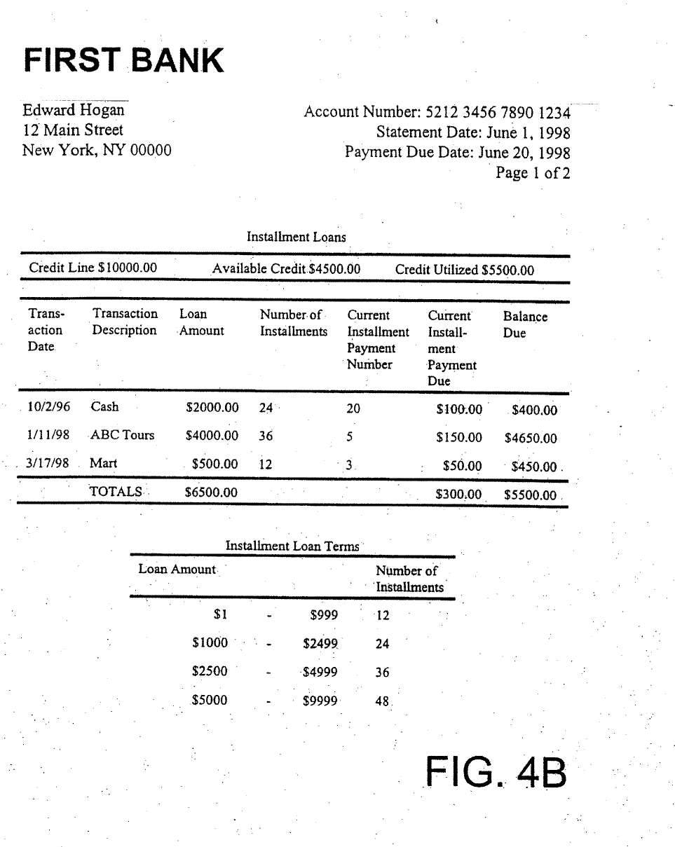

In step 170, the payment terms for installment loans accessed using the installment loan feature of the virtual and/or physical financial transaction card are determined. As illustrated in FIG. 4B, the payment terms may include a predetermined number of installment payments based on a range of loan amounts. In addition, the payment terms may include predetermined interest rates based a range of loan amounts (not illustrated). The payment terms may be established generally by the financial institution for all account holders or may be established by the financial institution on an account holder by account holder basis depending on an account holder's credit history. The financial institution may also allow the account holder to select certain payment term options on the application form (such as the number of installment payments for a loan range).

Referring to FIG. 1B, in step 180, the financial institution determines the installment loan criteria for the virtual and/or physical financial transaction card account. The installment loan criteria, when met, trigger the installment loan processing of a purchase made with the financial transaction card, as opposed to the processing of the purchase based on revolving credit. The installment loan criteria may include, for example, the type of a transaction (e.g., cash advance), the dollar amount of a transaction, or the merchant classification code of the merchant involved in a transaction. The installment loan criteria may also include whether a request has been made for a balance transfer, which may itself be triggered by the use of a convenience check, by a phone call requesting a balance transfer, or by a batch transmission from the issuer. These criteria may be specified by the financial institution or may alternatively be selected by account holders. In addition, there may be more than one criterion associated with a financial transaction account that triggers an installment loan. A default criterion, such as “No Installment Loans,” may also be established for those account holders that do not wish to take advantage of the installment loan features available with their cards.

Preferably, the determinations made in steps 160, 170, and 180 are stored in the account holder's account record. In steps 190 and 195, if a new financial transaction card (virtual and/or physical) account has been created, a new physical and/or virtual card may be issued to the account holder.

A financial transaction card account having the installment loan feature (whether physical, virtual, or both) may be tied to one or more different installment loans, each with separate rates and terms. That is to say, each purchase made by account holder using the financial transaction card (whether physical or virtual) may not only be for a different amount, but may also carry a different minimum monthly payment and a different interest rate. For example, referring to FIG. 4B, an account holder may make one purchase at ABC Tours, and a second purchase at Mart using the installment feature of the financial transaction card. The purchase from ABC Tours may, for example, be paid at $150.00 a month for 36 months at a rate of 6%, and the purchase at Mart may be paid at $50.00 a month for 12 months at a rate of 8%. These purchases along with revolving credit purchases may appear on one monthly financial transaction card statement and the amount due may be combined into a single minimum monthly payment.

A financial transaction card account having the installment loan feature (whether physical, virtual, or both) may also be linked to a primary account or credit line that is shared by a group of persons such as, for example, a family. In this example, a primary account holder (e.g., the head of the household) and the sub-account holders (e.g., the head of household's children) would each have an assigned credit limit. In the example of a family, for example, an overall credit line for the family's primary account may be $10,000. The primary account holder, who may be the head of the household, may have an assigned credit limit of $7,000, while each of the primary account holder's two children may be sub-account holders, each having a $1,500 limit. Each sub-account holder may, for example, have a physical or virtual financial transaction card with its own separate card number that is linked to the number of the primary account holder's account, with the activity and account status of the primary account holder and each of the sub-account holders being summarized in a billing statement. The primary account holder could optionally set up the sub-account such that some or all of the purchases made using the sub-account numbers will install. This is a useful tool for parents wishing to instruct their children in responsible use of financial transaction cards and budgeting as each sub-account holder would know the exact amount of his or her monthly payment, and exactly how long it will take to pay the account off in full.

In another exemplary embodiment of the financial transaction card having an installment loan feature according to the present invention, a business may set up an installment card account as a “lodged account.” A lodged account may be, for example, a virtual corporate card account that is “lodged” with one of the business' vendors. For example, a business may prefer that the travel expenses of its employees be billed to it through its travel agency. Such a business may lodge its financial transaction card account with the travel agency, causing all of the business' travel costs for one or more employees to be billed to that account, or to multiple accounts linked to a primary financial transaction card account. In accordance with an example of the present invention, a financial transaction card having an installment loan feature could be lodged with a vendor, such as (but not limited to) a travel agency, with certain installment triggers set up, e.g., a merchant category trigger to have all airfare and hotel purchases install.

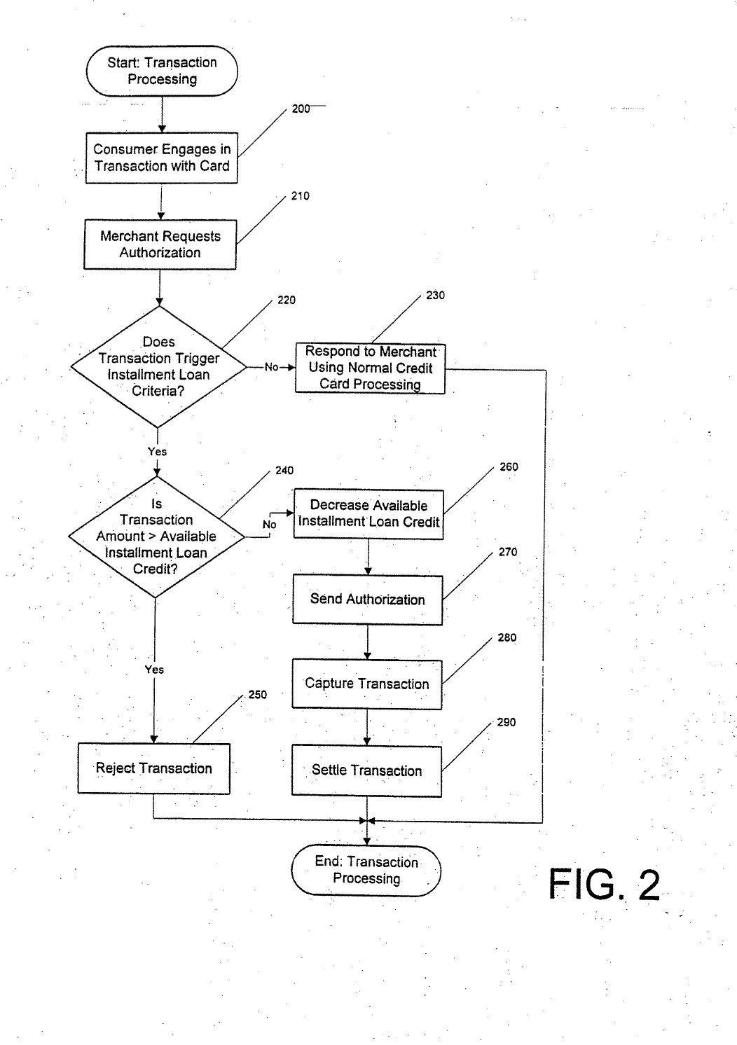

FIG. 2 is a flowchart illustrating the steps for processing a transaction in a financial transaction card system with an installment loan feature according to a preferred embodiment of the present invention. In step 200, an account holder engages in a transaction with a physical and/or virtual financial transaction card having the installment loan feature. In step 210, the merchant engaged in the transaction requests authorization for the transaction from the merchant bank or its agent. The merchant bank or its agent communicates the request to the interchange or the issuing financial institution or its agent.

In step 220, the interchange or the financial institution or its agent determines whether the transaction triggers one or more of the criteria for installment loan processing specified for the financial transaction card account of the account holder. In step 230, if the transaction does not trigger any of the criteria for installment loan processing, normal financial transaction card processing is performed—i.e., the financial institution or its agent accepts or rejects the transaction based on at least a determination of whether the transaction would exceed the credit line of the financial transaction card account. If one or more of the criteria for installment loan processing is triggered, in step 240 the interchange or the financial institution or its agent determines whether the transaction amount is greater than the available installment loan credit amount, which is equal to the installment loan credit limit minus the total installment loans balances due for the financial transaction card account. If the transaction amount exceeds the available installment loan credit amount, the transaction is rejected in step 250. Alternatively, if the transaction amount exceeds the available installment loan credit amount, the transaction may be accepted or rejected under normal financial transaction card processing procedures. If the transaction amount does not exceed the available installment loan amount, in steps 260 and 270, the available installment loan credit amount is decreased by the transaction amount and the transaction is accepted by sending an authorization code to the merchant.

It is should be noted that in steps 260 and 270, the authorization reduces the available credit amount but preferably does not actually put a charge on the account holder's account. It is preferred that a account holder's account is not charged during authorization because bank card associations, such as MasterCard International Incorporated®, have promulgated rules that do not allow a merchant to charge or capture a transaction until goods are shipped or services are delivered. Thus, it is preferable for the charging or capturing process to be performed separately in step 280. After the charging or capturing step, settlement occurs in step 290. As explained above, transactions are usually captured and accumulated into a “batch,” which are then settled as a group.

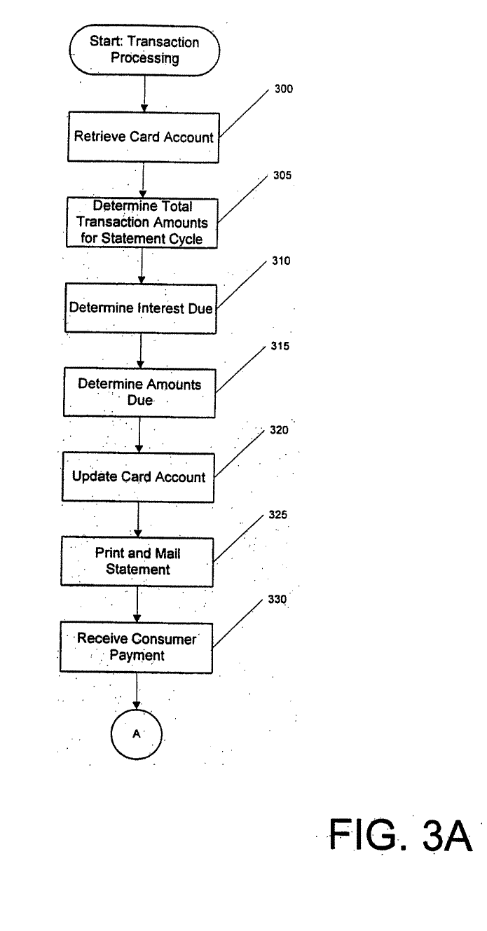

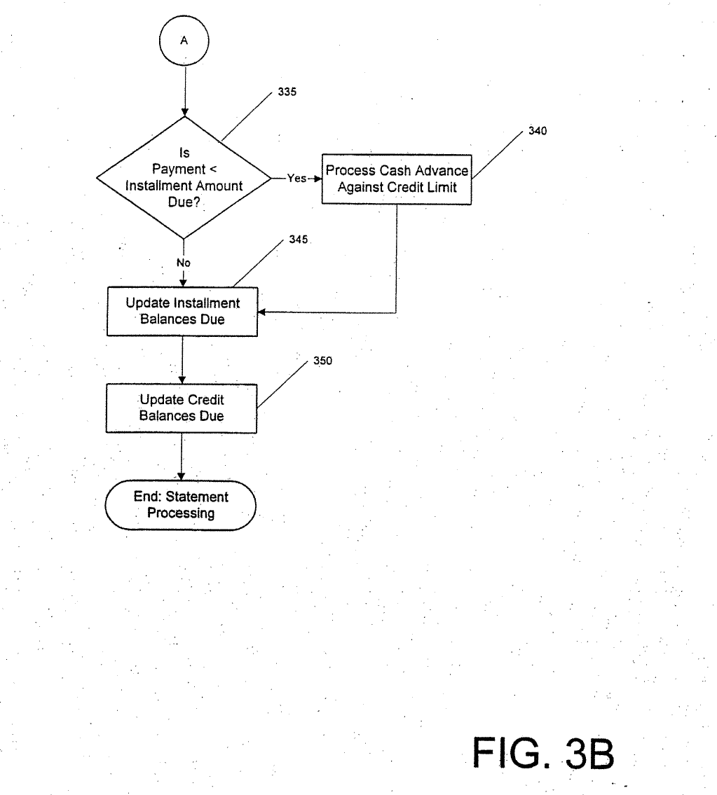

FIGS. 3A and 3B are flowcharts illustrating the steps for processing a statement for a financial transaction card with an installment loan feature according to a preferred embodiment of the present invention. The statements are typically processed on a monthly basis. In step 300, the card account record is retrieved from the financial institution's database. In step 305, the transactions that have been captured for the card account, both on a credit and on an installment loan basis, are totaled. In step 310, the interest due on previously unpaid credit balances and on new installment loans is calculated. In steps 315 and 320, the new amounts due on both credit and installment loan activities are calculated and the card account record is updated.

In step 325, the statement is printed and mailed. FIGS. 4A and 4B illustrate a preferred embodiment of a statement produced by a financial transaction card system according to the present invention. As shown, the statement lists a summary of the credit and the installment loan activities on the first page. The statement lists a detailed description of the credit and the installment loan activities on the first and second pages, respectively. As shown in FIG. 4B, for each loan, the detailed description of the installment loan activity preferably includes the date of the loan, the description of the loan, the loan amount, the total number of installment payments due, the current installment payment number, the current installment payment amount due, and the total installment loan balance due. In addition, it is also preferred that the installment loan terms are listed on the same page as the detailed description of the installment loan activity to remind the account holder of these terms.

Returning to FIG. 3A, in step 330, after mailing the statement, a payment is received from the account holder. Referring to FIG. 3B, in step 335, it is determined whether the payment received is less than the installment loan amount due. If the payment is less than the installment loan amount due, a cash advance in the amount of the difference between the payment received and the installment loan amount due is preferably charged against the account holder's credit line in step 340. Alternatively, payment collection procedures may be implemented in this step.

If a sufficient payment is received in step 335 or a deficiency is processed in step 340, in step 345 the installment loan balances are updated to reflect the payment. In step 350, any payment amount received above the installment loan amount due is applied against the credit balance due. In steps 345 and 350, the card account record is updated accordingly.

Although the present invention has been described with reference to certain preferred embodiments, various modifications, alterations, and substitutions will be known or obvious to those skilled in the art without departing from the spirit and scope of the invention, as defined by the appended claims.

We claim:

1. In a financial transaction payment system comprising a processing unit and an application program executing on the processing unit, a method of conducting a transaction, comprising:
engaging in the transaction using a financial transaction card, the financial transaction card having associated therewith a financial account with a financial institution;
determining, by the application program, an amount of a line of credit to be accessed on the financial account to pay for the transaction; and
establishing, by the application program, repayment terms for the transaction, the repayment terms including a fixed number of installment payments.

2. The financial transaction payment system of claim 1, wherein the number of installment payments is established based on the amount of the line of credit accessed for the transaction.

3. The financial transaction payment system of claim 2, wherein the repayment terms further include a particular interest rate.

4. The financial transaction payment system of claim 3, wherein the particular interest rate is established based on the amount of the line of credit accessed for the transaction.

5. The method of claim 4, further comprising the step of determining by the application program whether the amount of the transaction is greater than the available installment loan credit amount.

6. The method of claim 5, further comprising the step of decreasing by the application program the available credit amount by the amount of the transaction if the amount of the transaction is less than or equal to the available credit amount.

7. The method of claim 6, wherein the available credit amount is shared between installment loan purchases and revolving credit purchases.

8. The method of claim 7, wherein the financial transaction card may be used to make both installment loan purchases and revolving credit purchases.

9. The method of claim 1, wherein the financial transaction card is a physical card.

10. The method of claim 1, wherein the financial transaction card is a virtual card.

11. The method of claim 7, wherein the financial transaction card account is linked to one or more different financial transaction card numbers.

12. A method for generating a statement for a financial transaction card, the financial transaction card having an associated installment balance and an associated credit balance, comprising:
obtaining a record for a card account associated with the financial transaction card;
retrieving from the card account record information about each credit transaction and each installment transaction associated with the card account for a particular period; and
displaying a single minimum payment for a combined credit transaction and installment transaction balance.

13. The method of claim 12, wherein the displayed installment transaction details include, for each retrieved installment transaction, a date on which the installment transaction occurred, a total number of installments, and an amount due on a current installment.

14. The method of claim 13, further comprising:
displaying, for each retrieved installment transaction, a description of the installment transaction.

15. The method of claim 14, further comprising:
displaying, for each retrieved installment transaction, an installment payment number.

16. The method of claim 15, further comprising:
displaying, for each retrieved installment transaction, a total balance due.

17. The method of claim 16, further comprising:
displaying a number of installment payments required for a particular installment transaction amount.

18. The method according to claim 17, further comprising:
displaying an amount of credit available for future installment transactions.

19. The method according to claim 17, further comprising:
displaying an amount of credit available for future installment transactions and future credit transactions.

20. The method of claim 17, further comprising:
displaying, for each retrieved credit transaction, credit transaction details including an amount of the credit transaction.

21. The method of claim 20, further comprising:
displaying the credit transaction details on a first page of the statement, and the installment transaction details on a second page of the statement.
